(19) United States
(12) Patent Application Publication
(10) Pub. No.: US 2016/0347970 A1
(43) Pub. Date: Dec. 1, 2016

(54) LIQUEFIED WOOD COATING

(71) Applicant: ADVANCED WOOD PAINT, LLC, GRAYSON, GA (US)

(72) Inventor: CHRISTOPHER R. BOEST, GRAYSON, GA (US)

(21) Appl. No.: 15/236,387

(22) Filed: Aug. 12, 2016

Related U.S. Application Data
(63) Continuation-in-part of application No. 14/601,932, filed on Jan. 21, 2015.
(60) Provisional application No. 61/939,051, filed on Feb. 12, 2014.
(60) Provisional application No. 62/268,387, filed on Dec. 16, 2015.

(51) Int. Cl. C09D 197/02; B27K 3/02; C09D 133/04

(52) U.S. Cl. CPC C09D 197/02; C09D 133/04; B27K 3/02

(57) ABSTRACT

Disclosed are various embodiments relating to a liquefied wood coating that can be applied to virtually any surface. The liquefied wood coating contains a micronized wood powder, a non-elastomeric resin with high adhesion properties, and an elastomeric resin for flexibility. Once dried, the wood coating accepts stain, polyurethane, and other types of coatings to provide a real wood finish. A single-step process producing a pre-stained wood coating is also disclosed, as is the use of a universal colorant system to tint one or more base colors of liquefied wood coating.

### CROSS-REFERENCE TO RELATED APPLICATIONS

This application is a continuation-in-part of U.S. application Ser. No. 14/601,932, entitled “LIQUEFIED WOOD COATING,” and filed on Jan. 21, 2015, which claims the benefit of U.S. Provisional Application No. 61/939,051, filed on Feb. 12, 2014. This application also claims the benefit of U.S. Provisional Application No. 62/268,387, filed on Dec. 16, 2015. All of the above-stated applications are incorporated herein by reference in their entirety.

### BACKGROUND

People often wish to refinish cabinetry, furniture, and other decorative surfaces. For example, the finishes may become worn, or they may simply be outdated. Sometimes, where the surface is wood, the surface may be stripped and/or sanded down and a new finish may be applied. Such a process may be labor intensive and messy. In some cases, the surface may be merely a veneer or laminate, and the only refinishing possible may be to paint or to place a new laminate layer. Faux finish paint systems are expensive, and they require multiple steps and professional application to create a simulated wood finish. Due to these limitations, people often choose to replace their cabinetry, furniture, etc., rather than go through the expense and hassle of refinishing.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a flowchart illustrating one example of a process of use for a liquefied wood coating according to an embodiment of the present disclosure.

FIG. 2 is a flowchart illustrating one example of a process of manufacture for a single-step liquefied wood coating according to an embodiment of the present disclosure.

FIG. 3 is a flowchart illustrating one example of a process of use for a single-step liquefied wood coating according to an embodiment of the present disclosure.

### DETAILED DESCRIPTION

The present disclosure relates to a liquefied wood coating that may be used as a stainable primer. Creating a stained wood finish on a bare, non-wood surface or a painted surface may be difficult and expensive. It may involve stripping a painted surface down to the original wood surface and refinishing. Non-wood surfaces may require professional faux finishes or expensive manufacturing laminating processes to create a wood finish on a non-wood surface. The coating described herein allows anyone to brush, spray, roll on, drip on, or otherwise apply a layer of liquefied wood that, when dry, allows the user to apply any available wood stain, creating the look of a real wood finish.

The liquefied wood coating described herein may be applied via a single step process that is easy to use for the average non-professional user. It is cost effective and provides a real wood stainable surface for most clean and hard surfaces. By contrast, faux finish paint systems create a simulated, near wood appearance by layering many different paints and glazes to give a wood-like appearance, not a real wood coating. Faux finish paint systems are difficult to use and require many steps to complete the process. The liquefied wood coating described herein dries quickly and creates a wood layer that can be stained with any commercially available stain. The components of the liquefied wood coating will next be described.

The components of the liquefied wood coating include a micronized wood powder and a blend of two different resins: (1) an extremely high performance, non-elastomeric adhesive resin that dries very hard with high stick qualities and (2) an elastomeric resin to provide flexibility. The resin blend has a small particle size with a low demand for co-solvent. For example, an acrylic resin may be used for the hard resin, and an elastomeric vinyl acrylic resin may be used for the flexible resin. The blend of the two different resins provides high adhesion plus flexibility. For example, a formulation of 15-35% vinyl acrylic resin and 5-20% acrylic resin may be selected by weight. The proportion of resins is selected to provide high enough adhesion while still allowing for absorption into the wood particles. Higher resin content translates into a lower absorbability.

In various embodiments, the hardness of the liquefied wood coating that has been applied and dried may be quantified using the ASTM D3363 Standard Test Method for Film Hardness by Pencil Test, thereby producing a result of “HB” (softer) to “H” (harder). In various embodiments, the adhesion of the liquefied wood coating that has been applied to a previously painted surface and has dried may be quantified using the ASTM D3359 Standard Test Methods for Measuring Adhesion by Tape Test, specifically using the crosshatch adhesion method, thereby producing a result of “3B” (slight separation of the surface) to “5B” (no failure). In various embodiments, the flexibility of the liquefied wood coating that has been applied to a metal surface and has dried may be quantified using ASTM D522 Standard Test Methods for Mandrel Bend Test, specifically the conical mandrel method, which may produce a result of no failure. In various embodiments, the minimum film forming temperature may be less than zero.

The liquefied wood coating may also include normal paint fillers, which can include a lacquer base, a naphtha base, or a water base. For example, lacquer may be avoided in houses for safety reasons, but otherwise it is quick to dry compared to water. In one embodiment, the liquefied wood coating may be formulated as a caulk. The caulk may be formulated in an elastomeric acrylic with a proper blend of wood powder to create an environment that would accept stain.

The micronized wood powder comprises fine wood particles. The wood particles used in the liquefied wood coating are preferably smaller than 200 mesh. In some instances, the wood particles may be selected to be smaller than 400 to 1500 mesh. It is understood that the wood particles used in the liquefied wood coating may be a blend of different particle sizes. That is to say, when incorporating 200 mesh wood particles into the liquefied wood coating, there may be some wood particles of greater size than 200 mesh in the mixture, but the mixture substantially comprises particles smaller than 200 mesh. In varying the size of the wood particles, properties of the liquefied wood coating may also change.

The wood particles may be from various wood species. For example, oak, maple, walnut, pine, spruce, eucalyptus, walnut shell, almond, almond shell, balsa, pecan, pecan shell, ash, mahogany, and other wood species may be used. Different woods may have slightly different properties. In some cases, the wood particles used in the liquefied wood coating may comprise a blend of woods from different species. The color of the liquefied wood coating may be described as a generic wood color. Small percentages of pigments (e.g., between 1% and 4% of pre-dispersed pigments (waterborne pigments for waterborne systems and industrial solvent pigments for solvent-based systems) may be added to produce different wood colors. However, it is noted that a light wood color will allow for a choice of stain colors. In one scenario, the liquefied wood coating may be distributed in three base colors: a light color, a medium color, and a dark color, to simulate different color of wood. The coating when dried may be further stained to achieve any variation.

The liquefied wood coating described herein will bond to almost any solid surface. Such surfaces may include, but are not limited to, wood, medium density fiberboard (MDF), particleboard, gypsum board, plastic, fiberglass, glass, fiber cement board, vinyl composition tile, metal, ceramic, polyvinyl chloride (PVC) trim, masonry, leather, a previously stained surface, a previously painted surface, and other surfaces. When dried, the liquefied wood coating does not come off unless scraped off.

The thickness of the coating depends on the amount of absorption. In one embodiment, applying the liquefied wood coating results in a 0.5-3 mil thickness wood composition upon the surface to which it is applied. This wood composition also has filler properties and can level out minor imperfections in the surface. For example, the wood composition can fill imperfections by using multiple coats. This wood composition absorbs stain into the wood like real wood. The dried wood coating can accept other coatings besides stain, including paint, polyurethane, and other coatings. Thus, the dried wood coating may be used as a primer for paint, etc., due to its opacity and filler properties. Upon drying, 50-60% by weight of the coating may remain on the surface.

Different applicators may give different surface results. For example, applying the liquefied wood coating with a paintbrush may result in brush strokes that mimic real wood grain when stain is applied. In some cases, scuffing of the dried surface may be used to mimic wood grain. If a sprayer is used, there will be no brush strokes and hence a grainless appearance. Thus, the finished appearance may be varied depending on the method of application.

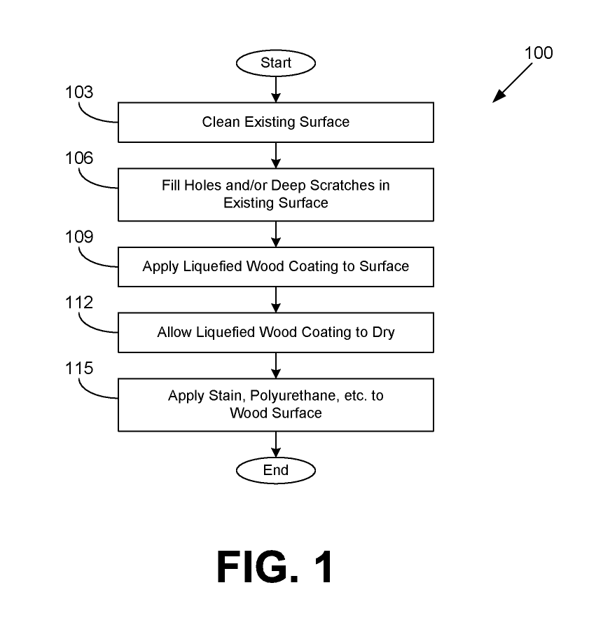

A method of use will next be described with reference to FIG. 1. The flowchart 100 of FIG. 1 illustrates one example application of the liquefied wood coating to a surface. Beginning with box 103, the existing surface is cleaned and allowed to dry. In box 106, holes, deep scratches, and/or other imperfections in the existing surface are filled in. For example, a filler product that does not contain silicone may be used. In box 109, the liquefied wood coating is applied to the surface. Application may be by way of a brush, rag, sprayer, curtain coater, drip coater, roller, or other applicator. In some cases, an object having the surface may be immersed in the liquefied wood coating. For example, the coating may be between 0.5 and 3 mils thick. In box 112, the liquefied wood coating is allowed to dry, e.g., approximately two hours. In box 115, stain, paint, polyurethane, and/or additional coatings are applied to the dried wood surface. The micronized wood particles within the dried wood surface will absorb the stain, paint, polyurethane, etc. The flowchart 100 then ends.

Another embodiment involves a single-step process of applying a liquefied wood coating. Unlike in the multiple-step process described above, the wood is pre-stained in the single-step process. Refinishing materials with a stained wood finish to include wood and materials other than wood is difficult, time consuming, and expensive, so reducing the steps involved where possible is beneficial. The one-step coating process described herein replaces all of the steps required to finish or faux finish any hard surface or wood surface. For the average consumer, staining or faux finishing requires a high skill level and specialized equipment to produce a high-quality wood stain finish on nearly any hard surface. The single-step process lends itself especially well to a spray can application format. Although referred to as a “one-step” process, it is understood that the single-step process may involve multiple coatings of the same product to ensure uniform coverage. Also, clear coatings and/or additional stains could be added later if desired.

The materials used to produce the one-step liquefied wood coating can include a micronized wood powder (e.g., 1-50 microns; 1200-300 mesh) manufactured from hardwood (e.g., 40-90%), inorganic mineral powder (e.g., 10-60%; 1-20 microns; 1200-600 mesh) such as talc (e.g., 1-5%) (which is a functional extender and protectant for exterior use) and titanium dioxide (e.g., 1-10%) (which is used to increase opacity), reactive and non-reactive dyes, organic and inorganic liquid and powdered colorants, water or solvents (both catalyzed and non-catalyzed), and water-based and solvent-based resins/binders (e.g., Sycoat 2020, which is water based, and Setalux, which is solvent based).

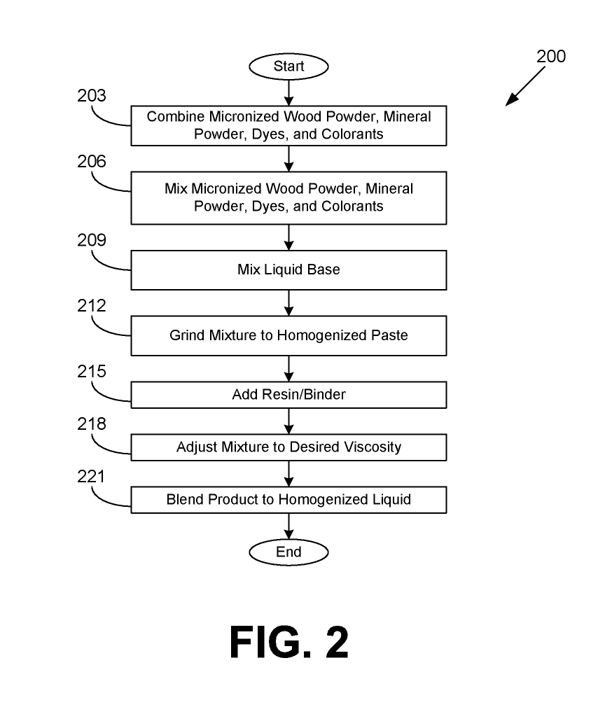

A method for making the one-step liquefied wood coating is described with reference to the flowchart 200 of FIG. 2. To make the one-step liquefied wood coating, the micronized wood powder, the inorganic mineral powder, the dyes, and the colorants are combined together at box 203 and mixed and dispersed at box 206. The same size particles of micronized wood powder may be used in both the single-step and two-step processes. The proportions of the micronized wood powder, the inorganic mineral powder, the dyes, and the colorants can be varied to produce corresponding variations in the wood color. A desired liquid base is (water or another solvent) is then added at box 209, and the mixture is ground to create a homogeneous paste at box 212.

A resin/binder designed for the application is then added at box 215 (water-based resins for water based product, or solvent-based resins for the selected solvent), and the product is mixed and adjusted to a desired viscosity at box 218. A low viscosity is used for spray applications (e.g., measured at 15-30 seconds using a Zahn #2 flow cup) and for brushing applications (e.g., measured at 22-40 seconds using a Zahn #2 flow cup). Finally, the product is blended to a homogenous liquid at box 221. Thereafter, the flowchart 200 ends.

The inorganic mineral powders such as talc and titanium dioxide add neutral filler properties. The reactive and non-reactive dyes allow the wood and fillers to be pre-colored or pre-stained in a limitless color range to create any wood shade or tone. Pigments or colorants allow the solution color range to be adjusted in a full range of opacity and intensity to create limitless finishing effects. The pigment quantity can be adjusted to very low levels (e.g., 0.1-2%), and the coating will still perform its function. Pigments are minerals such as perlite or iron oxide that do not look like wood. Dyes such as aniline, by contrast, penetrate the cellulose of the wood particles. Pigments have pure opacity, while dyes are semi-transparent.

Water or solvents allow the solution to be produced in a wide range of liquid media suited to different applications. Resins or binders are selected to match the liquid base to allow the solution to adhere to and obtain the desired properties for the particular application. When these components are combined at various percentages, a liquefied wood coating is created that when dry recreates a real wood finish in an endless color and texture range that will adhere to most any hard surface.

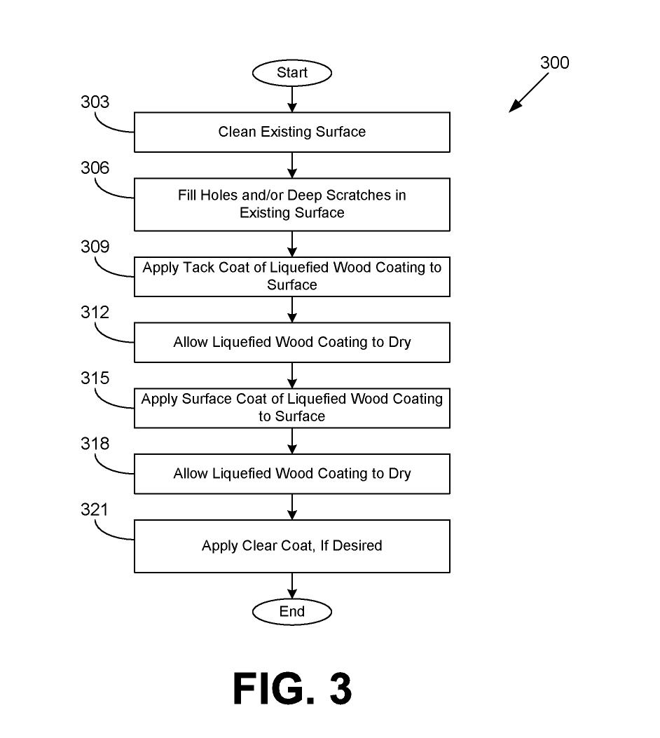

Next, a method of use is described with reference to the flowchart 300 of FIG. 3. First, the surface to receive the coating is prepared. For example, the surface may be cleaned and/or degreased at box 303. Any loose material is removed. Holes and/or deep scratches in the existing surface may be filled at box 306. The one-step liquefied wood coating is next applied using a brush, a roller, or a spray system. A thin tack coat is first applied at box 309, which is allowed to completely dry at box 312. The use of a tack coat can allow a brush stroke to be added to impart a grain effect to the surface. A second full coat is then applied at box 315, which is allowed to completely dry at box 315. A clear coat may be applied at box 321 if desired to protect the final finish and achieve a desired matte or gloss level. Thereafter, the flowchart 300 of FIG. 3 ends.

The liquefied wood coatings described herein may be made compatible with one or more universal colorant systems. In a universal colorant system, a liquid coating is sold in one or more base colors. A customer is able to select from a range of color samples, corresponding to different wood colors or stain colors. A color formula is identified, and small quantities of colorants corresponding to the formula are added to the coating by an automated machine in order to tint the coating. Such colorants may include pigments and/or dyes that are mixed with ethylene glycol, propylene glycol, or other chemicals that are generally non-reactive. The container of liquid coating is then agitated by stirring or shaking so that the colorants are evenly disbursed within.

However, it is noted that not every universal colorant system is compatible with liquefied wood coatings. Using too much pigment (e.g., greater than 10%) is problematic, as is using pure metallic dyes, which could cause the liquefied wood coating to gel up or turn into foam. Pure pigment systems are to be avoided unless extremely small quantities are used (e.g., six drops per gallon), while combination dye and pigment systems are favored.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A liquefied wood coating, comprising:
a micronized wood powder substantially consisting of wood particles of a size 200 mesh or smaller;
a combination of a pigment and a dye selected to provide a stain color for the liquefied wood coating;
a non-elastomeric adhesive resin; and
an elastomeric resin.

2. The liquefied wood coating of claim 1, wherein the micronized wood powder substantially consists of wood particles of a size 400 mesh or smaller.

3. The liquefied wood coating of claim 1, wherein the micronized wood powder substantially consists of wood particles from hardwood species.

4. The liquefied wood coating of claim 1, further comprising a base selected from the group consisting of: a lacquer base, a naphtha base, and a water base.

5. The liquefied wood coating of claim 1, wherein the non-elastomeric adhesive resin is an acrylic resin, and the elastomeric resin is an acrylic vinyl elastomeric resin.

6. A wood-coated surface, comprising:
a base surface; and
a liquefied wood coating applied to the base surface, the wood coating comprising micronized wood particles, a combination of a dye and a pigment, an elastomeric resin, and a non-elastomeric adhesive resin, the micronized wood particles substantially consisting of wood particles having a size of 200 mesh or smaller.

7. The wood-coated surface of claim 6, wherein the micronized wood particles substantially consists of wood particles of a size 400 mesh or smaller.

8. The wood-coated surface of claim 6, wherein the micronized wood particles comprise at least one of: oak wood particles, maple wood particles, or walnut wood particles.

9. The wood-coated surface of claim 6, wherein the liquefied wood coating further comprises an inorganic mineral powder.

10. The wood-coated surface of claim 6, wherein a sealer has been applied to the wood coating.

11. The wood-coated surface of claim 6, wherein the base surface is selected from the group consisting of: a gypsum board surface, a plastic surface, a medium density fiberboard (MDF) surface, a masonry surface, a glass surface, a ceramic surface, a leather surface, and a metal surface.

12. The wood-coated surface of claim 6, wherein the wood coating was applied to the base surface in a liquefied form.

13. The wood-coated surface of claim 6, wherein the non-elastomeric adhesive resin is an acrylic resin, and the elastomeric resin is an acrylic vinyl elastomeric resin.

14. A method for applying a finish to a surface, comprising:
applying a liquefied wood coating to the surface, the liquefied wood coating including micronized wood particles, a combination of a dye and a pigment, an elastomeric resin, and a non-elastomeric adhesive resin.

15. The method of claim 14, further comprising, after the liquefied wood coating dries upon the surface, applying a sealing coating to the surface.

16. The method of claim 14, further comprising adding at least a portion of the dye or the pigment through an injection by a universal colorant system.

17. The method of claim 14, wherein the dye comprises a non-reactive dye and a reactive dye.

18. The method of claim 14, wherein the surface is a non-wood surface.

19. The method of claim 14, wherein the surface is a gypsum board surface.

20. The method of claim 14, wherein the micronized wood particles of the liquefied wood coating substantially consist of wood particles having a size of 200 mesh or smaller.
